(19) United States
(12) Patent Application Publication
(10) Pub. No.: US 2010/0068237 A1
(43) Pub. Date: Mar. 18, 2010

(54) MICROEMULSION GERMICIDAL COMPOSITION

(76) Inventors: Qiang Li, Lake Forest, CA (US); Chris French, Mission Viejo, CA (US); Charles Roberts, Long Beach, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/609,196

(22) Filed: Oct. 30, 2009

Related U.S. Application Data
(63) Continuation-in-part of application No. PCT/US2009/042269, filed on Apr. 30, 2009.
(60) Provisional application No. 61/049,994, filed on May 2, 2008.

(51) Int. Cl. A01N 25/04; A01N 35/04; A01P 1/00

(52) U.S. Cl. 424/405; 514/699

(57) ABSTRACT

A germicidal composition comprising an aromatic dialdehyde; a medium chain linear alcohol; a surfactant; at least one enhancer selected from the group consisting of a halide salt, a carbonate and a carboxylate salt; and water, wherein the germicidal composition is a microemulsion.

### CROSS-REFERENCE TO RELATED APPLICATION

This application is a continuation-in-part of PCT/US2009/042269, filed on 30 Apr. 2009, which claims priority from U.S. Application Ser. No. 61/049,994, filed on May 2, 2008.

### FIELD

The present invention relates to microemulsion germicidal compositions that may be used for disinfection or sterilization.

### BACKGROUND INFORMATION

Various aldehyde-based germicidal compositions are known in commerce and have been discussed in the literature. Among the more prevalent of the aldehyde-based germicidal compositions are those including formaldehyde, glutaraldehyde, or o-phthalaldehyde (also known simply as phthalaldehyde). Phthalaldehyde has certain advantages over formaldehyde and glutaraldehyde. Formaldehyde is potentially carcinogenic and has an objectionable odor. Glutaraldehyde likewise has an objectionable odor, and may be chemically unstable during storage. Phthalaldehyde is generally not regarded to be carcinogenic, is substantially odorless, and has rapid germicidal action. Due to these and other advantages, there is a general need in the arts for new and improved germicidal compositions containing phthalaldehyde.

US2005/0136086 describes germicidal compositions having a germicidal dialdehyde and efficacy enhancing halide salts or carbonates. This reference discloses phthalaldehyde germicidal compositions exhibiting enhanced log reduction after 4 hours of contact with Bacillus subtilis spores. CN1836508A describes phthalaldehyde microemulsion compositions that include ortho-phthalaldehyde, an aliphatic alcohol A, an aliphatic alcohol B, a chelating agent, a quaternary ammonium salt, a nonionic surfactant, a pH buffer system, a foam inhibitor and a metal corrosion inhibiting compound, wherein the preferred embodiment of CN1836508A is described as achieving greater than a 5 log reduction within 30 minutes of contact with Bacillus subtilis spores.

Germicidal efficacy and the time to achieve disinfection or sterilization are generally important characteristics of germicidal compositions. There remains a general need in the arts for new and improved germicidal compositions that have high germicidal efficacies and more rapid germicidal activity than the compositions of the prior art.

### DETAILED DESCRIPTION

The microemulsion germicidal compositions described herein are useful for disinfection or sterilization and are generally capable of achieving greater than a 5 log reduction within 15 minutes or less of contact with Bacillus subtilis spores.

The microemulsion germicidal compositions disclosed herein are liquid compositions that include an aromatic dialdehyde as an active ingredient. Examples of such aromatic dialdehydes include but are not limited to phthalaldehyde, also known as o-phthalaldehyde or 1,2-benzenedicarboxaldehyde, and 1,3-benzodioxole-4,5-dicarboxaldehyde (CAS 52315-62-5):

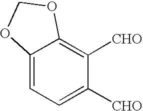

The aromatic dialdehyde may be used in the microemulsion germicidal compositions described herein in an amount less than about 0.8% by weight of the total composition. For example, phthalaldehyde may be used in an amount ranging from about 0.025 to about 0.8%, preferably in an amount ranging from about 0.05 to about 0.8%, and more preferably in an amount ranging from about 0.1 to about 0.6%.

The microemulsion germicidal compositions described herein also include at least one medium chain linear alcohol having from about 3 to about 12 carbons atoms, in an amount less than about 25% by weight of the total composition. Preferably, the amount of the alcohol ranges from about 2 to about 25%, and more preferably from about 11 to about 20%. Examples of such an alcohol include but are not limited to 1-propanol, 1-butanol and 1-pentanol. Preferably, the medium chain alcohol is 1-propanol.

In addition to the components described above, the microemulsion germicidal compositions described herein include at least one surfactant in an amount less than about 10% by weight of the total composition, which when used together with the medium chain linear alcohol results in a microemulsion system. Nonionic, cationic and anionic surfactants may be utilized. Preferably, the surfactant is a nonionic surfactant that is used in an amount ranging from about 0.5 to about 10%, and more preferably from about 2 to about 8%. Examples of such a surfactant include but are not limited to polysorbates, alkyl poly(ethylene oxide) and alkyl polyglycosides. Particular examples of alkyl polyglycosides include but are not limited to APG-0810 (commercially available from Spec-Chem Industry, Inc.), and BIO-SOFT FF-400 and BIO-SOFT N23-6.5 (both commercially available from Stephan).

Finally, the microemulsion germicidal compositions described herein include at least one enhancer selected from the group consisting of halide salts, carbonates, and carboxylate salts, in an amount less than about 15% by weight of the total composition. Preferably, the enhancer is used in an amount ranging from about 0.5 to about 15%, and more preferably from about 1 to about 5%.

Examples of the halide salt include but are not limited to organic halide salts and inorganic metal halide salts such as alkali metal halide salts. Exemplary alkali metal halide salts include lithium halides, sodium halides, potassium halides, and combinations thereof. The halides may include fluorides, chlorides, bromides, or iodides. Exemplary alkali metal fluorides include lithium fluoride, sodium fluoride, potassium fluoride, and combinations thereof. Exemplary alkali metal chlorides include lithium chloride, sodium chloride, potassium chloride, and combinations thereof. Exemplary alkali metal bromides include lithium bromide, sodium bromide, potassium bromide, and combinations thereof. Exemplary alkali metal iodides include lithium iodide, sodium iodide, potassium iodide, and combinations thereof.

Examples of carbonates include, but are not limited to carbonate salts and bicarbonate salts. Exemplary carbonate salts include, but are not limited to, sodium carbonate (Na₂CO₃), potassium carbonate (K₂CO₃), calcium carbonate (CaCO₃), magnesium carbonate (MgCO₃), lithium carbonate (Li₂CO₃), and combinations thereof. Suitable bicarbonate salts include, but are not limited to, sodium bicarbonate (NaHCO₃), potassium bicarbonate (KHCO₃), lithium bicarbonate (LiHCO₃), and combinations thereof. A preferred carbonate is potassium carbonate.

Examples of the carboxylate salts include, but are not limited to potassium acetate and potassium citrate.

The microemulsion germicidal compositions disclosed herein may optionally contain non-flammable organic solvents including, but not limited to, glycerol, 1,2-propanediol, and polyethylene glycol. The microemulsion germicidal compositions disclosed herein may optionally contain quaternary ammonium compounds such as didecyldimethylammonium chloride, didecyl dimethyl benzyl ammonium chloride (Maquat® 4480-E from Mason Chemical) and benzalkonium chloride.

Optionally, penetrants, chelating agents, anti-foaming reagents, corrosion inhibitors, dyes, fragrances, and other desired components may be utilized in the microemulsion germicidal compositions described herein, in amounts appropriate to achieve the desired penetrating, chelating, corrosion inhibition, coloring, or other effect.

Exemplary penetrants include, but are not limited to, laurocapram, fatty alcohol ethoxylates, and menthol.

Examples of suitable chelating agents that may be employed in the microemulsion germicidal composition include, but are not limited to, BDTA (N,N′-1,4-butanediylbis[N-(carboxymethyl)]glycine), EDTA (ethylenediaminetetraacetic acid), various ionized forms of EDTA, EGTA (N″-ursodeoxycholyl-diethylenetriamine-N,N,N′-triacetic acid), PDTA (N,N′-1,3-propanediylbis[N-(carboxymethyl)]glycine), TTHA (3,6,9,12-tetraazatetradecanedioic acid, 3,6,9,12-tetrakis(carboxymethyl)), trisodium HEDTA (N-[2[bis(carboxymethyl)amino]ethyl]-N-(2-hydroxyethyl)-glycine, trisodium salt), sometimes known as Versenol 120. Numerous other chelating agents known in the arts may also optionally be employed.

Anti-foaming reagents that may be used in the microemulsion germicidal composition described herein include, but are not limited to, such as Merpol® A (commercially available from Stepan), polyethylene glycol and dimethyl polysiloxanes.

Examples of suitable corrosion inhibitors that may be employed in the microemulsion germicidal composition include, but are not limited to, ascorbic acid, benzoic acid, benzoimidazole, citric acid, 1H-benzotriazole, 1-hydroxy-1H-benzotriazole, phosphate, phosphonic acid, pyridine, and sodium benzoate. Numerous other corrosion inhibitors known in the arts may also optionally be employed.

Examples of suitable dyes that may be employed in the germicidal composition include, but are not limited to, Blue 1 (Brilliant Blue FCF) if a bluish color is desired, D&C Green No. 5, D&C Green No. 6, and D&C Green No. 8, if a greenish color is desired, Yellow No. 5 if a yellowish color is desired, etc. Numerous other dyes known in the arts may also optionally be employed.

Generally, the enhancement of germicidal efficacy increases with increasing pH or alkalinity. For example, the pH of the microemulsion germicidal compositions described herein generally range from about 8 to about 13, and preferably from about 9.5 to about 11.5. Acids, bases, buffers or other pH adjusters may optionally be employed for any desired pH adjustment. Examples of suitable pH adjusters include, but are not limited to, sodium hydroxide (NaOH) and hydrochloric acid. For example, the microemulsion germicidal compositions described herein may include a base such as hydroxides of alkali metals and alkaline earth metals like sodium hydroxide (NaOH), in an amount ranging from about 0.01 to about 0.2%, and preferably in amount of about 0.05%. The buffers that may be used with the microemulsion germicidal compositions described herein preferably maintain the pH in the range from about 8 to about 13, and preferably in the range from about 9.5 to about 11.5. Examples of such buffers include, but are not limited to, EDTA tetra-salt form/HCl, borax/HCl and phosphate buffer.

The microemulsion germicidal compositions described herein have a number average particle size ranging from about 1 to about 500 nm, preferably from about 2 to about 150 nm, and more preferably from about 2.5 to about 80 nm. The particle size and distribution of OPA sample can be determined by Nanotrac particle size analyzer (Microtrac Inc.) or any equivalent light scattering device.

The microemulsion germicidal compositions described herein are generally prepared as described below in the examples, and are generally capable of achieving greater than a 5 log reduction within 15 minutes or less of contact with Bacillus subtilis spores, according to the procedure set forth in the examples. Specifically, Examples 1-3, 5-7, 9, and 11-12 and 14 achieved a 6 log reduction within 15 minutes; while Examples 4 and 10 achieved a 5 log reduction within 5 minutes, after contact with Bacillus subtilis spores. A preferred embodiment of the present invention, Example 11, was capable of achieving greater than a 6 log reduction in 2.5 minutes, which represents a significant improvement in germicidal efficacy and time to achieve disinfection or sterilization over known germicidal compositions.

### Examples

### Example 1

Example 1

| | | Weight (g) |
|---|---|---|
| 1. | OPA | 0.6 |
| 2. | Glycerol | 15 |
| 3. | EDTA Disodium Salt | 1 |
| 4. | Laurocapram | 0.2 |
| 5. | K₂CO₃ | 4 |
| 6. | KAc | 1 |
| 7. | Merpol A | 1 |
| 8. | Alkyl polyglycosides | 8 |
| 9. | Benzotriazole | 0.01 |
| 10. | H₂O | 53.7 |
| 11. | Maquat ® 4480-E (Mason Chemical) | 0.5 |
| 12. | 1-Propanol | 15 |
| | Total weight | 100.01 |

Appearance: clear yellow

Prepare 1 mg/mL benzotriazole solution: accurately weigh 100 mg benzotriazole and transfer into 100 mL volumetric flask. Dilute to volume with deionized water and mix well.

Based on above formulation table, accurately weigh components 1˜8 and 11 and transfer into the same bottle. Add 10 mL 1 mg/mL benzotriazole solution into the bottle. Then add 43.7 mL dH₂O. Keep stirring >2 hours. The solution will be cloudy. Slowly add 1-propanol into above solution. After adding 6˜7 mL 1-propanol, the solution will become clear. Finally add ˜15 g (18.66 mL) 1-propanol. Keep stirring and mix well. Filter through 0.45 μm membrane before the further testing.

Sporicidal Test:
1) Add 9 mL test formulation to a sterile test tube labeled “Testing Solution”.
2) Then add 1 mL B. subtilis spore suspension (˜10⁷ cfu/ml containing ˜5% FBS*) to “Testing Solution” tube, begin timing and mix. *FBS: Fetal Bovine Serum
3) Take 1 mL test samples at time 10 minutes or other certain time points and neutralize test samples as described below:
   a. Wet filter unit membrane with ˜10 mL glycine/lecithin/Fluid D*** mix prior to collecting test sample. ***Glycine/lecithin/Fluid D mix: 500 mL 1% glycine & 500 mL modified Fluid D (modified Fluid D: 1% Tween 80 with Lecithin)
   b. Add 1 mL test sample. Immediately filter.
   c. Immediately add 100 mL Neutralizer****. Filter. ****Neutralizer: 100 mL 10% glycine & 900 mL Neutralizing media (Neutralizing media: 1% Tween 80 and 0.3% lecithin)
   d. Add 3×100 mL aliquots of glycine/lecithin/Fluid D mix, filtering after each aliquot.
   e. Aseptically transfer filter membrane to a labeled TSA plate and incubate 2-7days at 36° C.
4) Repeat steps 1-3 for each formulation to be tested.
5) For (+) control, dilute 1 mL B. subtilis spore suspension (˜10⁷ cfu/ml) 10-fold and perform serial dilutions. Spread respective serial dilution onto a labeled TSA** plate and incubate 2-7 days at 36° C. **TSA: Tryptic (Trypticase) Soy Agar

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 187, 160, | 1.90E+06 | 6.28 | n/a |
| 10\hat{ }4 | | 223 | | | |
| Dilution | | | | | |
| Example 1 | 10 | 0, 0, 0 | 0 | 0 | >6.28 |
| Example 1 | 10 | 5, 3, 8 | 5.3 | 0.73 | 5.55 |
| (1:1.3 | | | | | |
| Dilution) | | | | | |

*(+) control: the spore suspension without adding test sample
The 1:1.3 dilution preparation: e.g. add 15 g deionized into 50 g Example 1 and mix well.

Number average particle size of Example 1 is 25.06 nm.

### Examples 2 and 3

Example

| | |
|---|---|
| 2 | 3 |

Weight (g)

| | | |
|---|---|---|
| 1. OPA | 0.3 | 0.3 |
| 2. Glycerol | 7.5 | 7.5 |
| 3. EDTA Disodium Salt | 0.5 | 0.5 |
| 4. Laurocapram | 0.1 | 0 |
| 5. K₂CO₃ | 2 | 2 |
| 6. KAc | 0.5 | 0.5 |
| 7. Merpol A | 0.5 | 0.5 |
| 8. Alkyl polyglycosides | 4 | 4 |
| 9. Benzotriazole | 0.005 | 0.005 |
| 10. H₂O | 27.1 | 26.8 |
| 11. Maquat ® 4480-E | 0 | 0.4 |
| 12. 1-Propanol | 7.5 | 7.5 |
| Total weight | 50.005 | 50.005 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 24, 26, 24 | 2.47E+06 | 6.39 | n/a |
| 10\hat{ }5 | | | | | |
| Dilution | | | | | |
| Example 2 | 5 | 78, 71, 58 | 69 | 1.84 | 4.55 |
| Example 3 | 5 | 3, 2, 4 | 3 | 0.48 | 5.91 |
| (+) control | n/a | 29, 38, 33 | 3.33E+06 | 6.52 | n/a |
| 10\hat{ }5 | | | | | |
| Dilution | | | | | |
| Example 2 | 10 | 0, 0, 0 | 0 | 0 | >6.52 |
| Example 3 | 10 | 0, 0, 0 | 0 | 0 | >6.52 |

### Example 4

Example 4

| | | Weight (g) |
|---|---|---|
| 1. | OPA | 0.6 |
| 2. | Glycerol | 15 |
| 3. | EDTA | 1 |
| | Disodium Salt | |
| 4. | K₂CO₃ | 4 |
| 5. | KAc | 1 |
| 6. | Merpol A | 1 |
| 7. | Alkyl | 8 |
| | polyglycosides | |
| 8. | Benzotriazole | 0.01 |
| 9. | H₂O | 54.4 |
| 10. | 1-Propanol | 15 |

| | |
|---|---|
| Total weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 244, 234, | 2.57E+06 | 6.41 | n/a |
| 10\hat{ }4 | | 292 | | | |
| Dilution | | | | | |
| Example | 5 | 6, 8, 11 | 9.3 | 0.92 | 5.49 |
| 4 - Test 1 | | | | | |
| Example | 5 | 7, 4, 7 | 6 | 0.78 | 5.63 |
| 4 - Test 2 | | | | | |

Number average particle size of Example 4 is 2.77 nm.

### Example 5

Example 5

| | Weight (g) |
|---|---|
| 1. OPA | 0.6 |
| 2. Glycerol | 5 |
| 3. EDTA | 1 |
| Disodium Salt | |
| 4. K₂CO₃ | 4 |
| 5. Merpol A | 0.5 |
| 6. Alkyl | 4 |
| polyglycosides | |
| 7. Benzotriazole | 0.01 |
| 8. H₂O | 66.9 |
| 9. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 356, 420, | 3.95E+06 | 6.60 | n/a |
| 10\hat{ }4 | | 409 | | | |
| Dilution | | | | | |
| Example | 5 | 1, 0, 0 | 0.3 | 0.00 | >6.60 |
| 5 - Test 1 | | | | | |
| Example | 5 | 1, 1, 0 | 0.7 | 0.00 | >6.60 |
| 5 - Test 2 | | | | | |

### Example 6

Example 6

| | Weight (g) |
|---|---|
| 1. OPA | 0.6 |
| 2. EDTA | 1 |
| Disodium Salt | |
| 3. K₂CO₃ | 4 |
| 4. Merpol A | 0.5 |
| 5. Alkyl | 4 |
| polyglycosides | |
| 6. Benzotriazole | 0.01 |
| 7. H₂O | 71.9 |
| 8. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 25, 19, 24 | 2.27E+06 | 6.36 | n/a |
| 10\hat{ }5 | | | | | |
| Dilution | | | | | |
| Example | 5 | 0, 0, 0 | 0 | 0.00 | >6.36 |
| 6 - Test 1 | | | | | |
| Example | 5 | 0, 0, 0 | 0 | 0.00 | >6.36 |
| 6 - Test 2 | | | | | |

Number average particle size of Example 6 is 7.06 nm.

### Example 7

Example 7

| | Weight (g) |
|---|---|
| 1. OPA | 0.6 |
| 2. K₂CO₃ | 4 |
| 3. Merpol A | 0.5 |
| 4. Alkyl | 2 |
| polyglycosides | |
| 5. Benzotriazole | 0.01 |
| 6. H₂O | 74.9 |
| 7. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 425, 430, | 4.41E+06 | 6.64 | n/a |
| 10\hat{ }4 | | 468 | | | |
| Dilution | | | | | |
| Example | 5 | 3, 0, 0 | 1 | 0.00 | >6.64 |
| 7 - Test 1 | | | | | |
| Example | 5 | 0, 0, 0 | 0 | 0.00 | >6.64 |
| 7 - Test 2 | | | | | |

### Example 8

Example 8

| | Weight (g) |
|---|---|
| 1. OPA | 0.6 |
| 2. K₂CO₃ | 2 |
| 3. Merpol A | 0.5 |
| 4. Alkyl | 4 |
| polyglycosides | |
| 5. Benzotriazole | 0.01 |
| 6. H₂O | 74.9 |
| 7. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 25, 30, 22 | 2.57E+06 | 6.41 | n/a |
| 10\hat{ }5 | | | | | |
| Dilution | | | | | |
| Example | 10 | 1, 4, 2 | 2.3 | 0.36 | 6.05 |
| 8 - Test 1 | | | | | |
| Example | 10 | 23, 26, 26 | 25 | 1.40 | 5.01 |
| 8 - Test 2 | | | | | |
| Example | 15 | 0, 0, 0 | 0 | 0.00 | >6.41 |
| 8 - Test 1 | | | | | |
| Example | 15 | 7, 10, 15 | 10.7 | 1.03 | 5.38 |
| 8 - Test 2 | | | | | |

### Example 9

Example 9

| | Weight (g) |
|---|---|
| 1. OPA | 0.6 |
| 2. K₂CO₃ | 1.5 |
| 3. KHCO₃ | 7.5 |
| 4. Merpol A | 0.5 |
| 5. Alkyl | 4 |
| polyglycosides | |
| 6. Benzotriazole | 0.01 |
| 7. H₂O | 67.9 |
| 8. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 24, 41, 39 | 3.47E+06 | 6.54 | n/a |
| 10\hat{ }5 | | | | | |
| Dilution | | | | | |
| Example | 5 | 10, 15, 18 | 14.3 | 1.16 | 5.38 |
| 9 - Test 1 | | | | | |
| Example | 5 | 15, 16, 18 | 13 | 1.11 | 5.43 |
| 9 - Test 2 | | | | | |
| Example | 15 | 0, 0, 0 | 0 | 0.00 | >6.54 |
| 9 - Test 1 | | | | | |
| Example | 15 | 0, 0, 0 | 0 | 0.00 | >6.54 |
| 9 - Test 2 | | | | | |

### Example 10

Example 10

| | Weight (g) |
|---|---|
| 1. OPA | 0.6 |
| 2. K₂CO₃ | 1 |
| 3. KAc | 8 |
| 4. Merpol A | 0.5 |
| 5. Alkyl | 4 |
| polyglycosides | |
| 6. Benzotriazole | 0.01 |
| 7. H₂O | 67.9 |
| 8. 1-Propanol | 18 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 61, 57, 54 | 5.73E+06 | 6.76 | n/a |
| 10\hat{ }5 | | | | | |
| Dilution | | | | | |
| Example | 5 | 25, 27, 20 | 24 | 1.38 | 5.38 |
| 10 - Test 1 | | | | | |
| Example | 5 | 30, 41, 40 | 37 | 1.57 | 5.19 |
| 10 - Test 2 | | | | | |

### Example 11

Example 11

| | Weight (g) |
|---|---|
| 1. OPA | 0.2 |
| 2. EDTA | 0.2 |
| Disodium Salt | |
| 3. K₂CO₃ | 5 |
| 4. Merpol A | 0.2 |
| 5. Alkyl | 5 |
| polyglycosides | |
| 6. Benzotriazole | 0.01 |
| 7. H₂O | 69.4 |
| 8. 1-Propanol | 20 |
| Total Weight | 100.01 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 271, 258, | 2.68E+06 | 6.43 | n/a |
| 10\hat{ }4 | | 274 | | | |
| Dilution | | | | | |
| Example | 2.5 | 0, 3 | 1.5 | 0.18 | 6.25 |
| 11 - Test 1 | | | | | |
| Example | 2.5 | 0, 0 | 0 | 0.00 | >6.43 |
| 11 - Test 2 | | | | | |
| Example | 5 | 0, 0 | 0 | 0.00 | >6.43 |
| 11 - Test 1 | | | | | |
| Example | 5 | 0, 0 | 0 | 0.00 | >6.43 |
| 11 - Test 2 | | | | | |

### Example 12

Example 12

| | Weight (g) |
|---|---|
| 1. OPA | 0.6 |
| 2. K₂CO₃ | 5 |
| 3. Alkyl | 4 |
| polyglycosides | |
| 4. H₂O | 70.4 |
| 5. 1-Propanol | 20 |
| Total Weight | 100 |

Example 12 dilution (0.45% OPA) preparation: e.g. add 10 g deionized water into 30 g Example 12 and mix well.

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control 10\hat{ }4 | n/a | 250, 241, 245 | 2.45E+06 | 6.39 | n/a |
| Dilution | | | | | |
| Example 12 Dilution | 5 | 3, 2 | 2.5 | 0.40 | 5.99 |
| (0.45% OPA) - Test 1 | | | | | |
| Example 12 Dilution | 5 | 42, 58 | 50 | 1.70 | 4.69 |
| (0.45% OPA) - Test 2 | | | | | |
| Example 12 Dilution | 10 | 0, 0 | 0 | 0.00 | 6.39 |
| (0.45% OPA) - Test 1 | | | | | |
| Example 12 Dilution | 10 | 0, 0 | 0 | 0.00 | 6.39 |
| (0.45% OPA) - Test 2 | | | | | |

### Example 13

Example 13

| | | Weight (g) |
|---|---|---|
| 1. | 1,3-benzodioxole-4,5- | 0.3 |
| | dicarboxaldehyde | |
| 2. | Glycerol | 7.5 |
| 3. | EDTA Disodium Salt | 0.5 |
| 4. | Laurocapram | 0.1 |
| 5. | K₂CO₃ | 2 |
| 6. | KAc | 0.5 |
| 7. | Merpol A | 0.5 |
| 8. | Alkyl polyglycosides | 4 |
| 9. | Benzotriazole | 0.005 |
| 10. | H₂O | 26.85 |
| 11. | Maquat ® 4480-E (Mason | 0.25 |
| | Chemical) | |
| 12. | 1-Propanol | 7.5 |
| | Total weight | 50.005 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 41, 47, 57 | 4.83E+06 | 6.7 | n/a |
| 10\hat{ }5 | | | | | |
| Dilution | | | | | |
| Example 13 | 5 | 92, 106, | 91 | 1.96 | 4.72 |
| | | 75 | | | |
| Example 13 | 5 | 78, 72, 54 | 68 | 1.83 | 4.85 |

### Example 14

Example 14 (pH 11.93)

| | Weight (g) |
|---|---|
| 1. OPA | 0.600 |
| 2. K₂CO₃ | 1.250 |
| 3. NaOH | 0.050 |
| 4. BIO-SOFT | 4.000 |
| N23-6.5 | |
| 5. 1-Propanol | 20.000 |
| 6. H₂O | 74.100 |
| Total Weight | 100.00 |

Sporicidal Test

| | Contact | log | |
|---|---|---|---|
| Test Solution | Time (min) | (Survivor) | log (Reduction) |
| (+) control | 0 | 6.88 | n/a |
| Example 14 | 5 | Confluent | Cannot determine |
| Example 14 | 10 | 0.7 | 6.18 |

### Comparative Examples 1-4

The preferred embodiment described in CN1836508A was prepared in Comparative Example 1. 1-propanol was used instead of 1-dodecanol in Comparative Examples 2-4 to prepare clear formulations.

| | | Comp. Example |
|---|---|---|
| | | 1 |
| 1. | OPA | 0.55 |
| 2. | DDAC | 0.2 |
| 3. | Glycerol | 15 |
| 4. | EDTA Disodium Salt | 0.5 |
| 5. | Alkyl polyglycosides | 2 |
| 6. | KH₂PO₄ | 0.16 |
| 7. | K₂HPO₄ | 0.57 |
| 8. | Polyethylene glycol 200 | 0.6 |
| 9. | Mercapto-triazole | 0.1 |
| 10. | Citric acid | 0.1 |
| 11. | C8-10 Fatty alcohol | 1 |
| | ethoxylates | |
| 12. | H₂O | 79.12 |
| 13. | 1-Dodecanol | 0.1 |
| | Total weight | 100 |

DDAC: Didodecyl dimethyl ammonium chloride

| | | Comp. Example | | |
|---|---|---|---|---|
| | | 2 | 3 | 4 |
| | | Weight (g) | | |
| 1. | OPA | 0.55 | 0.55 | 0.55 |
| 2. | DDAC | 0.4 | 0.4 | 0.4 |
| 3. | Glycerol | 5 | 5 | 5 |
| 4. | EDTA Disodium Salt | 0.5 | 0.5 | 0.5 |
| 5. | Alkyl polyglycosides | 2 | 2 | 2 |
| 6. | KH₂PO₄ | 0.1 | 0.1 | 0 |
| 7. | K₂HPO₄ | 0.53 | 0.53 | 0 |
| 8. | Polyethylene glycol 200 | 0.2 | 0.2 | 0.2 |
| 9. | Mercapto-triazole | 0.1 | 0.1 | 0.1 |
| 10. | Citric acid | 0.2 | 0 | 0.2 |
| 11. | C8-10 Fatty alcohol | 0.4 | 0.4 | 0.4 |
| | ethoxylates | | | |
| 12. | H₂O | 78.02 | 78.22 | 78.65 |
| 13. | 1-Propanol | 12 | 12 | 12 |

| | | | |
|---|---|---|---|
| Total weight | 100 | 100 | 100 |

Sporicidal Test

| | Contact | Plate | Avg. | | |
|---|---|---|---|---|---|
| | Time | Count | Survivor | log | log |
| Test Solution | (min) | (cfu) | (cfu) | (Survivor) | (Reduction) |
| (+) control | n/a | 69, 54, 65 | 6.27E+06 | 6.80 | n/a |
| 10\hat{ }5 | | | | | |
| Dilution | | | | | |
| Comp. | 120 | Confluent | n/a | n/a | n/a |
| Example 2 - | | | | | |
| Test 1 | | | | | |
| Comp. | 120 | Confluent | n/a | n/a | n/a |
| Example 2 - | | | | | |
| Test 2 | | | | | |
| Comp. | 120 | Confluent | n/a | n/a | n/a |
| Example 3 - | | | | | |
| Test 1 | | | | | |
| Comp. | 120 | Confluent | n/a | n/a | n/a |
| Example 3 - | | | | | |
| Test 2 | | | | | |
| Comp. | 120 | Confluent | n/a | n/a | n/a |
| Example 4 - | | | | | |
| Test 1 | | | | | |
| Comp. | 120 | Confluent | n/a | n/a | n/a |
| Example 4 - | | | | | |
| Test 2 | | | | | |

Comparative Example 1 was cloudy and no further sporicidal test was performed on this formulation. Sporicidal tests were performed for Comparative Examples 2-4 at 2 hours contact time and there was no significant sporicidal activity for Comparative Examples 2-4 at 2 hours contact time compared to Examples 1-13 under the same sporicidal test procedures.

While the invention has been described in terms of several embodiments, those skilled in the art will recognize that the invention is not limited to the embodiments described, but may be practiced with modification and alteration within the spirit and scope of the appended claims. The description is thus to be regarded as illustrative instead of limiting.

1. A germicidal composition comprising an aromatic dialdehyde; a medium chain linear alcohol; a surfactant; at least one enhancer selected from the group consisting of a halide salt, a carbonate and a carboxylate salt; and water, wherein the germicidal composition is a microemulsion.

2. The germicidal composition of claim 1 comprising less than 0.8% by weight aromatic dialdehyde, less than 25% medium chain linear alcohol, less than 10% surfactant, and less than 15% of the enhancer.

3. The germicidal composition of claim 2, wherein the aromatic dialdehyde is selected from the group consisting of phthalaldehyde and 1,3-benzodioxole-4,5-dicarboxaldehyde; the medium chain linear alcohol is selected from the group consisting of 1-propanol, 1-butanol and 1-pentanol; and the surfactant is selected from the group consisting of nonionic, cationic and ionic surfactants.

4. The germicidal composition of claim 3, wherein the surfactant is a nonionic surfactant and the enhancer is a carbonate.

5. The germicidal composition of claim 4, wherein the aromatic dialdehyde is phthalaldehyde.

6. The germicidal composition of claim 5, wherein the medium chain linear alcohol is 1-propanol and the carbonate is potassium carbonate.

7. The germicidal composition of claim 5, comprising about 0.025 to about 0.8% by weight phthalaldehyde, about 2 to about 25% medium chain linear alcohol, about 0.5 to about 10% nonionic surfactant, and about 0.5 to about 15% carbonate, wherein the germicidal composition microemulsion has a number average particle size ranging from 1 to 500 nm.

8. The germicidal composition of claim 7, comprising 0.05 to 0.6% by weight ortho-phthalaldehyde, 11 to 20% 1-propanol, 2 to 8% nonionic surfactant, and 1 to 5% potassium carbonate.

9. The germicidal composition of claim 8, wherein the germicidal composition microemulsion has a number average particle size ranging from 2 to 80 nm and a pH ranging from about 9.5 to about 11.5.

10. The germicidal composition of claim 1, further comprising a base.

11. The germicidal composition of claim 10, comprising about 0.025 to about 0.8% by weight phthalaldehyde, about 2 to about 25% medium chain linear alcohol, about 0.5 to about 10% nonionic surfactant, about 0.5 to about 15% carbonate, and about 0.01 to about 0.5% base, based on the total weight of the composition, wherein the germicidal composition microemulsion has a number average particle size ranging from 1 to 500 nm.

12. The germicidal composition of claim 11, wherein the medium chain linear alcohol is 1-propanol, the carbonate is potassium carbonate and the base is sodium hydroxide.
